(19) United States
(12) Patent Application Publication
(10) Pub. No.: US 2007/0011153 A1
(43) Pub. Date: Jan. 11, 2007

(54) Method and computer program product for generating a rank-ordered list of prospective customers

(75) Inventors: Ajay Pillai, Princeton Junction, NJ (US); Kevin Walsh, New York, NY (US); James Malaugh, North Plainfield, NJ (US); Nagendra Shishodia, Jersey City, NJ (US)

Correspondence Address: STAINBROOK & STAINBROOK, LLP, 3558 ROUND BARN BLVD., SUITE 203, SANTA ROSA, CA, 95403, US

(73) Assignee: INDUCTIS, INC., New Providence, NJ (US)

(21) Appl. No.: 11/179,694

(22) Filed: Jul. 11, 2005

(51) Int. Cl. G06F 17/30

(52) U.S. Cl. 707/5

(57) ABSTRACT

The present invention provides a method for generating a rank-ordered list of prospective customers for a user. The method includes the use of a predictive model for the generation of the rank-ordered list of prospective customers. A list of existing and prospective customers along with attributes characterizing each customer is input into the predictive model. The predictive model assigns scores to each customer. Finally, a rank-ordered list of prospective customers is generated from the input list, based on the scores assigned to each customer and the customized requirements of the user.

### BACKGROUND OF THE INVENTION

1. Field of the Invention

The present invention relates to the preparation of marketing lists. Specifically, the present invention relates to a method for generating a list of prospective customers for a user, in which the universe of available customers is rank-ordered using a predictive model.

2. Description of the Related Art

An important aspect of market research is having a clear view and understanding of the demographic characteristics of the customers who buy a particular product or service of interest. The development of a clear product-market insight makes it easy to identify prospective customers. The demographic characteristics of a prospective customer affect the customer's ‘propensity to buy’ a particular product. It is also important to distinguish between customers who would buy the product and those who would not, when given the opportunity to do so.

In general, existing customer databases tend to be used only on internal initiatives, while prospects are selected based on “rules of thumb” rather than being informed by this customer database. A clear and quantitative description of the customer base, as well as the utilization of this information to market effectively, is available today only at significant expense in terms of time and resources. Explicitly, an organization must have a data-rich infrastructure which stores and tracks marketing campaigns. After sufficient time has passed to allow extensive data collection, a team of modelers and business owners get together to mine this data for insights and build a customized model to optimize the customer acquisition process. This process must then be translated into a production scoring engine, which can execute campaigns on a regular basis.

Therefore, it is apparent from the above discussion that there is a need for a lower-cost statistical method that is able to build a rank-ordered list of prospective customers, given a list of requirements from a user, a list of known customers, and a prospective customer database, which is likely owned by a marketing data provider. This capability currently only exists in a handful of organizations with marketing budgets in the hundreds of millions of dollars.

### SUMMARY OF THE INVENTION

An objective of the present invention is to provide a method for generating a rank-ordered list of prospective customers for a user.

Another objective of the present invention is to generate this rank-ordered list of prospective customers using a predictive model.

Yet another objective of the present invention is to generate this rank-ordered list of prospective customers using a predictive model developed in a customized fashion for the user based on the customer list provided as input.

Still another objective of the present invention is to generate a finalized rank-ordered list of prospective customers, according to a list of requirements provided by the user.

To achieve the above-mentioned objectives in accordance with the purpose of the present invention as described, the present invention provides a method, system, and computer program product for generating a list of prospective customers.

The above method includes integrating an existing customer list into a marketing reference file, containing a large number of prospects. The integrated list of customers is input into a predictive model. Scores are assigned to each customer present in the integrated list based on the predictive model. Further, a list of prospective customers is created on the basis of the scores assigned to each customer present in the integrated list of customers.

Various embodiments of the present invention provide a list of prospective customers for a user based on the user's requirements. The rank-ordered list is generated based on the scores assigned by the predictive model described in the present invention and is not just based on the attributes/variables characterizing each record. Huge investments are required for obtaining such a large list of prospective customers. The present invention saves the cost incurred for obtaining such a large list, and the user needs to pay for only the list of prospective customers generated by the method described in the present invention. The present invention can provide prospective customer lists for different kinds of requirements for the same user or different users. Further, the method described in the present invention allows marketers of all sizes and budgets to generate their rank-ordered list of prospective customers with a fast turnaround that fits within existing marketing infrastructure.

### BRIEF DESCRIPTION OF THE DRAWINGS

So that the manner in which the above recited features of the present invention can be understood in detail, a more particular description of the invention, briefly summarized above, may be had by reference to various embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram of a system for generating a list of prospective customers for a user, in accordance with an embodiment of the present invention;

FIG. 2 is a flowchart of a method for generating a list of prospective customers for a user, in accordance with an embodiment of the present invention;

FIG. 3 provides a list of 50 independent variables, in accordance with an exemplary embodiment of the present invention;

FIGS. 4A, 4B, 4B and 4D represent a flowchart of a method for generating a list of prospective customers for a user, in accordance with another embodiment of the present invention;

FIG. 5 is a sample standardized customer list, in accordance with an exemplary embodiment of the present invention;

FIG. 6 shows a sample standardized customer list with a match level assigned to each record, in accordance with an exemplary embodiment of the present invention;

FIG. 7 shows a sample integrated marketing reference list, in accordance with an exemplary embodiment of the present invention;

FIG. 8 shows a sample standardized customer list of primary variables from which the address-state-affinity-ratio for address-state=NY, as illustrated in FIG. 10, is later calculated, in accordance with an exemplary embodiment of the present invention;

FIG. 9 shows a list of numerators of the address-state-affinity-ratios for address-states=NY, LA, OR, NJ, OH, CT and MA, in accordance with an exemplary embodiment of the present invention; and

FIG. 10 shows a subset of a sample integrated marketing reference list appended with a list of address-state-affinity-ratios, in accordance with an exemplary embodiment of the present invention.

### DETAILED DESCRIPTION OF THE INVENTION

For the sake of convenience, the terms used to describe the various embodiments are defined below. It should be noted that these definitions are provided to merely aid the understanding of the description, and that they in no way limit the scope of the present invention.

User: A user is a representative of a marketing organization who is providing the inputs required in the method described in various embodiments of the present invention.

Existing Customer: An entity which has an existing business relationship with the marketing organization represented by the user.

Prospective Customer (Prospect): An entity which does not have an existing business relationship with the marketing organization represented by the user.

Primary (Raw) Variable: A field provided as a part of each record in the marketing reference file.

Derived Variable: A variable obtained by operations performed on primary variables. Derived variables are also capable of characterizing an existing customer or prospect.

Independent variable: A variable that is not dependent on any other variable.

Dependent variable: A variable that is dependent on other variables and can be computed from independent or other dependent variables.

Dichotomous variable: A variable that takes mutually exclusive values.

Capped-variable: A derived variable representing an upper limit of a continuous primary variable.

Missing Indicator Variable: A derived binary variable that indicates whether a primary variable is present or missing.

Continuous variable: A variable that can take on any value and the different values taken by the variable have a numerical relationship between them.

Categorical Variable: A variable that takes on a number of values which are not necessarily related to one another.

Regional Indicator Variable: A derived variable that can take multiple values and represents a geographical attribute of an existing customer or prospect.

‘PRIMARY_SIC’: A variable that represents a Standard Industrial Classification Code. This is a code that describes the type of activity performed by an organization at a particular location. The Primary SIC code indicates the line of business that provides the largest revenue contribution to the organization. SIC codes apply to all types of businesses, organizations, and government locations.

Standard Industrial Classification (SIC): A derived variable that represents a part of the primary variable ‘PRIMARY_SIC’.

‘affinity-ratio’: A derived variable that represents the number of times a particular value of a corresponding primary variable is likely to occur in the existing customer population as compared to the entire existing customer and prospect population.

‘address-state’: A primary variable representing the state in which an organization is present.

‘address-state-affinity-ratio’: An affinity-ratio variable derived from primary variable ‘address-state’.

‘smsa-cd’: A primary variable that represents the Standard Metropolitan Statistical Area (SMSA) code that an organization is located in.

‘smsa_aff rat’: A variable derived from primary variable ‘smsa-cd’.

‘region_i’: A variable that takes the value equal to 1 if ‘address-state’ is selected from a group of defined values, else it takes the value equal to 0.

‘ceo-title’: A primary variable representing the full form of a title of an individual, for example, Owner, Partner, and President. The title of an individual is often abbreviated, for e.g., CEO, Pres, and the like.

‘population_cd’: A primary variable representing the residential population of the county in which an organization is located in. For example, the code is equal to 0 if the population is under 1000, the code is equal to 1 if the population is between 1000 and 2499, and the like.

‘sqr-footage’: A primary variable representing the actual square footage of the physical location occupied by an organization.

‘sales-volume’: A primary variable representing the annual sales volume of an organization.

‘capped-sales-volume’: A variable derived from primary variable ‘sales-volume’.

‘employee-total’: A primary variable representing the total number of employees in an organization.

‘nation_code’: A primary variable representing the code for the nation in which an organization is located.

‘state_cd’: A primary variable representing the code for the state in which an organization is located.

‘city_cd’: A primary variable representing the code for the city in which an organization is located.

‘ceo_first’: A primary variable representing the first name of the individual identified as having the chief executive function at a particular location of an organization.

The present invention provides a method, a system and a computer program product for generating a list of prospects for a user. A customer name along with the attributes/variables characterizing the customer is referred to as a record, wherein the customer may be a prospect or an existing customer. According to the method, an integrated existing customer and prospect list is prepared by combining a list of existing customers of the user and a marketing reference file. The marketing reference file includes prospects and existing customers of the user. The integrated existing customer and prospect list is input into a predictive model. The predictive model provides scores to each record present in the integrated existing customer and prospect list to obtain an output list of prospects. The output list of prospects does not contain any existing customers. The output list of prospects may be used in marketing campaigns and is likely to match the customer requirements of the user, better than a list of prospects that has not been modeled.

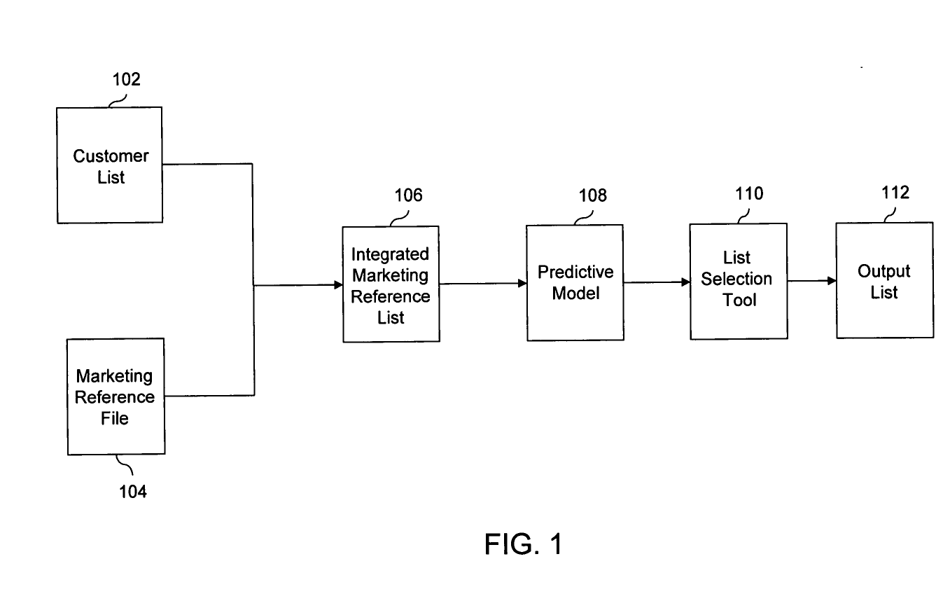

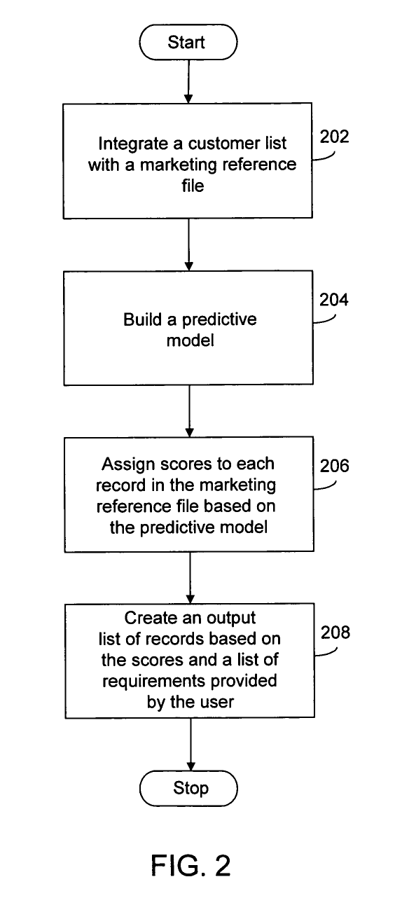

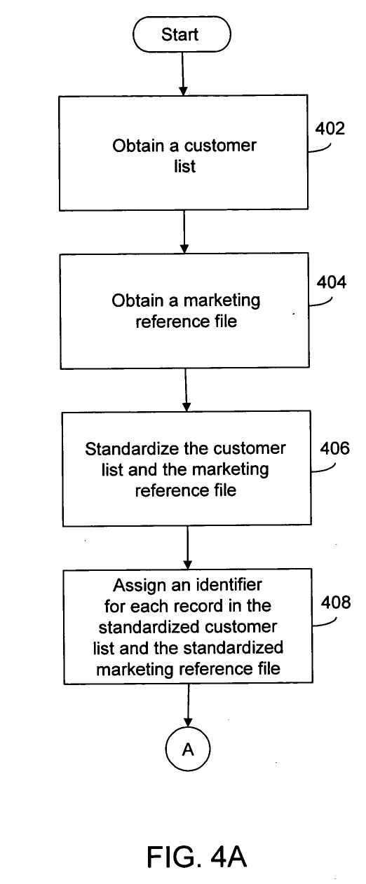

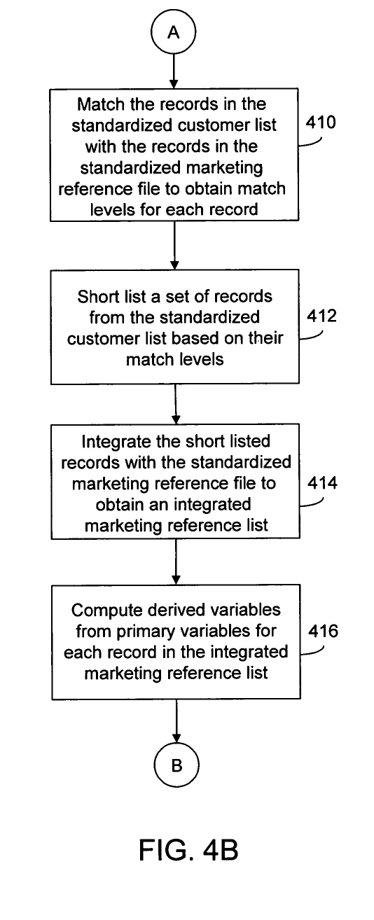

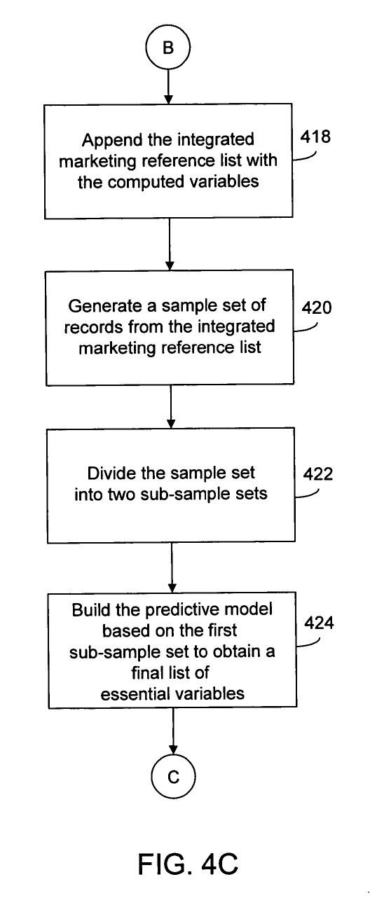

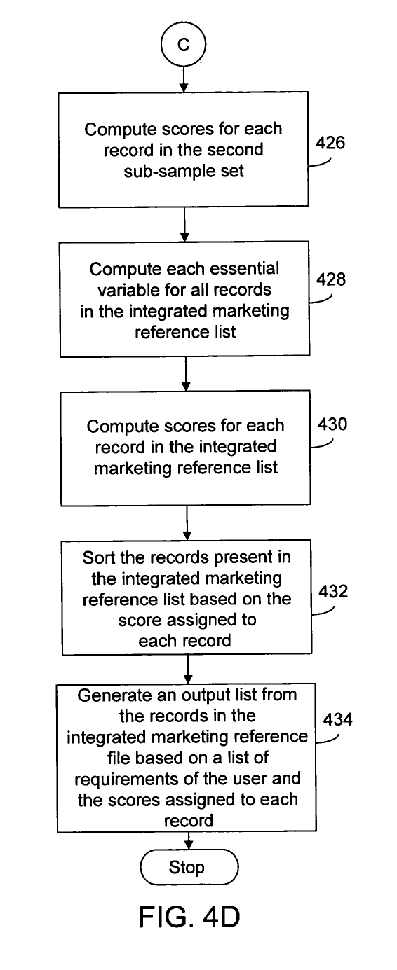

FIG. 1 is a flow diagram depicting a system for generating a list of prospects for a user, in accordance with an exemplary embodiment of the present invention. A customer list 102 includes a list of existing customers of the user. In an embodiment of the present invention, customer list 102 is provided by the user. Customer list 102 can also be obtained from a database that stores records of existing customers of an organization. A marketing reference file 104 includes a list of existing customers and prospects of the user. Marketing reference file 104 further includes one or more variables characterizing each existing customer and prospect present in marketing reference file 104. Some examples of these variables are the type of ownership, size, revenue, business age, number of employees, growth rate, and geography. In an embodiment of the present invention, marketing reference file 104 is provided by a marketing data provider. Examples of marketing data providers include, but not limited to, Dun & Bradstreet, InfoUSA, Experian, Equifax, TransUnion, Acxiom, Merkle, and Mal-Dunn. A customer name along with the variables characterizing the customer is referred to as a record, wherein the customer may be a prospect or an existing customer. Customer list 102 and marketing reference file 104 are combined to produce an integrated marketing reference list 106. Integrated marketing reference list 106 is input into a predictive model 108. An example of predictive model 108 is a logistic regression model. A list selection tool 110 creates an output list 112, which is a list of records based on predictive model 108, integrated marketing reference list 106, and customer list 102. The records in output list 112 represent prospects. Output list 112 is generated from integrated marketing reference list 106 according to scores assigned to each record present in integrated marketing reference list 106. Output list 112 does not contain any existing customers present in customer list 102. These scores are computed by predictive model 108. The method of computation of these scores is mentioned later in conjunction with FIG. 2 and FIG. 4. Further, output list 112 may be generated on the basis of a list of requirements provided by the user.

FIG. 2 is a flowchart of a method for generating a list of prospects for a user, in accordance with an embodiment of the present invention. At step 202, customer list 102 is integrated with marketing reference file 104 to obtain integrated marketing reference list 106. At step 204, predictive model 108 is built on the basis of integrated marketing reference list 106. Specifically, predictive model 108 is built on the basis of a plurality of variables present in integrated marketing reference list 106. In an embodiment of the present invention, predictive model 108 is a logistic regression model. Further, at step 204, a list of essential variables is short-listed from the variables present in integrated marketing reference list 106. At step 206, scores are assigned to each record present in integrated marketing reference list 106. The method of the computation of these scores is mentioned later in this patent application. At step 208, output list 112 is generated by list selection tool 110 on the basis of predictive model 108. Output list 112 is generated from integrated marketing reference list 106. The records present in output list 112 are short-listed on the basis of the scores assigned to them. In an embodiment of the present invention, output list 112 may further be short-listed on the basis of a list of requirements provided by the user. The list of requirements provided by the user may include demographic factors/preferences of the user, such as, but not limited to, the interest of the user to obtain customers in a particular location or customers meeting a minimum revenue threshold requirement.

The logistic regression model, also known as a logit model, is one of the predictive models employed in the present invention. The logistic regression model utilizes a form of regression that allows the prediction of a discrete outcome from a set of variables that may be continuous, discrete, dichotomous, or a combination thereof. It is used to estimate the probability of a certain even occurring. Independent or predictor variables in the logistic regression model can take any form. The logistic regression model makes no assumption about the distribution of the independent variables. Dependent or response variables can be dichotomous, such as success/failure or existing customer/prospective customer. A dependent variable in the logistic regression model can take the value 1 with a probability of success θ, or the value 0 with a probability of failure 1-θ.

The relationship between the independent and the dependent variables is not a linear function in the logistic regression model. Instead, a logistic regression function is used to predict this relationship, which is the logit transformation of θ given by equation (1):

$$θ = \frac{{ⅇ}^{( α + {β}_{1} {x}_{1} + {β}_{2} {x}_{2} + … + {β}_{i} {x}_{i} )}}{1 + {ⅇ}^{( α + {β}_{1} {x}_{1} + {β}_{2} {x}_{2} + … + {β}_{i} {x}_{i} )}} \qquad ( 1 )$$

where α represents the constant of the equation called the intercept, β represents the vector of coefficients of the independent variables, and xᵢ represents the value of the i^{th} independent variable. The process of calculation of the α and β coefficients in the logistic regression model is accomplished using standard procedures, once the variables present in the logistic regression equation have been chosen. In order to calculate the coefficients, a maximum likelihood estimation technique may be used. The likelihood function gives the probability of observing the particular set of dependant variable values which have occurred in the sample drawn. The maximum likelihood estimation process gives the parameter values, in this case the βs, for which the likelihood of observing the current sample is maximized. Statistical software packages for solving the logistic regression modes, such as SPSS, STATA, SAS and LIMDEP, are readily commercially available.

In an embodiment of the present invention, the logistic regression model is used for predicting a list of prospects for the user based on the scores assigned to each record in this list. The model predicts the presence in the user-input customer set, which is represented by not present in set (=0) and present (=1). The value of the score of a particular record, estimated by the logistic regression model, is given by θ which is computed using equation (1), where θ is the probability of that record representing a prospect.

An alternative form of the logistic regression equation is:

$$logit [ θ ( x ) ] = log [ \frac{θ ( x )}{1 - θ ( x )} ] = α + {β}_{1} {x}_{1} + {β}_{2} {x}_{2} + … + {β}_{i} {x}_{i} \qquad ( 2 )$$

In the above equation, θ(x) is the probability of the event ‘x’ occurring, wherein the event ‘x’ is dependent on the variables x₁, x₂, . . . , xᵢ. The logistic regression model includes all independent variables that are required to predict the dependent variables.

Several different options are available for the creation of the logistic regression model. In an embodiment of the present invention, variables are entered into the logistic regression model in an order specified by the user. In another embodiment of the present invention, the logistic regression model tests its fit after the coefficient of each variable is added and removed from the model.

Further, in an embodiment of the present invention, a backward elimination option of the logistic regression model is employed. In this option, the logistic regression model is run with all the variables present in integrated marketing reference list 106. Variables are eliminated from the model in an iterative process. The fit of the model is tested after the elimination of each variable to ensure that the model adequately fits the data. When no more variables can be eliminated from the model, the analysis is complete and a final list of essential variables is obtained.

An example of the use of the backward elimination option of the logistic regression model is provided herein. An initial list containing ‘k’ number of variables is input into the logistic regression model. The logistic regression model with all ‘k’ variables is known as a fully saturated logistic regression model. This fully saturated model is optimized or made fit by estimating the coefficients β for each independent variable, and the constant α of the logistic regression equation. Further, each coefficient is tested for significance by using a t-statistic with n-(k+1) degrees of freedom, where ‘n’ is the number of data observations and ‘k+1’ is the number of coefficients being estimated. The number of coefficients includes the constant of the logistic regression equation. The t-statistic for a coefficient, after the coefficient has been estimated, is the ratio of the coefficient to its standard error. This error can be tested against a t-distribution to determine the probability of the true value of the coefficient being equal to zero. After the coefficients and their t-statistics are estimated, the variable whose corresponding coefficient has the least significant t-statistic is removed from the initial list of ‘k’ variables. In the next step, the logistic regression model is input with ‘k−1’ variables, wherein the least significant variable has been removed from the initial list of ‘k’ variables. These iterations for the removal of the least significant variables are performed until the logistic regression model is fit and the t-statistics of the coefficients of the remaining variables meet a pre-determined minimum threshold criterion.

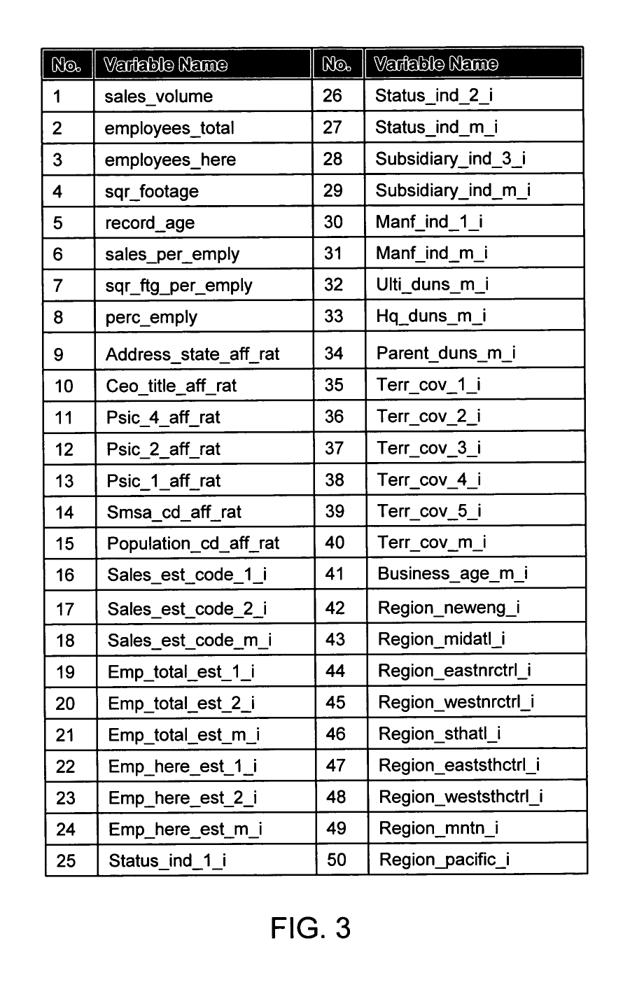

An example of the use of the logistic regression model to short-list a list of essential variables from the variables present in integrated marketing reference list 106 is provided herein, in accordance with an exemplary embodiment of the present invention. In an embodiment of the present invention, the short-listing of the essential variables using the logistic regression model is performed in three steps. In the first step, a list of independent variables present in integrated marketing reference list 106 is input into the logistic regression model. FIG. 3 provides a list of 50 sample independent variables, in accordance with an exemplary embodiment of the present invention. In this example, the backward elimination option of the logistic regression model has a pre-determined threshold criterion for the significance of the t-statistic as 0.10. In the second step, the initial list of independent variables is further divided into three lists based on the type of the variable, in accordance with an exemplary embodiment of the present invention. Exemplary categories include ‘geography’, ‘industry’ and ‘others’. Further, the variables remaining after the first step, in the geography and industry categories, are checked for multiple occurrences. Only one variable each, from the geography and industry categories, are input into the next run of the model. For example, if there are three variables in the geography list at the end of the first step, namely, address-state-affinity-ratio, smsa_aff_rat and region_i, only one variable address-state-affinity-ratio is input into the second run of the model and the other variables are removed from the geography list. Similarly, multiply occurring variables in the industry list are also removed. Further, in the third step, the variables obtained after the second step are input into the logistic regression model without the backward elimination option. The output of the third step is a list of essential variables and their respective coefficients.

It will be apparent to those skilled in the art that, factors such as lift and Kolmogorov-Smirnov (K-S) statistic can be used to validate the performance of the logistic regression model. The lift of the logistic regression model measures the accuracy and the speed by which an event can be captured by the logistic regression model. The lift is computed at a particular percentage of the population of records input in the model. For example, a lift of 90 percent means that 90 percent of the existing customer records get captured in the top 50 percent of the population of records in integrated marketing reference list 106, which are arranged by the descending probability of the event. In this case, the event is record type being equal to 1. K-S statistic is used as a relative indicator of a curve fit. It shows the degree of separation between the event and the non-event population.

FIGS. 4A, 4B, 4C and 4D represents a flowchart of a method for generating a list of prospects for a user, in accordance with another exemplary embodiment of the present invention. At step 402, customer list 102 of a user is obtained from the user. At step 404, marketing reference file 104 is obtained. Marketing reference file 104 includes a list of existing customers and prospects and a plurality of variables arranged in a pre-defined format. These variables characterize each customer, wherein the customer may be an existing customer or a prospect. At step 406, customer list 102 and marketing reference file 104 are standardized according to the pre-defined format to obtain a standardized customer list and a standardized marketing reference file. The method employed for the standardization of customer list 102 and marketing reference file 104 is described hereinafter.

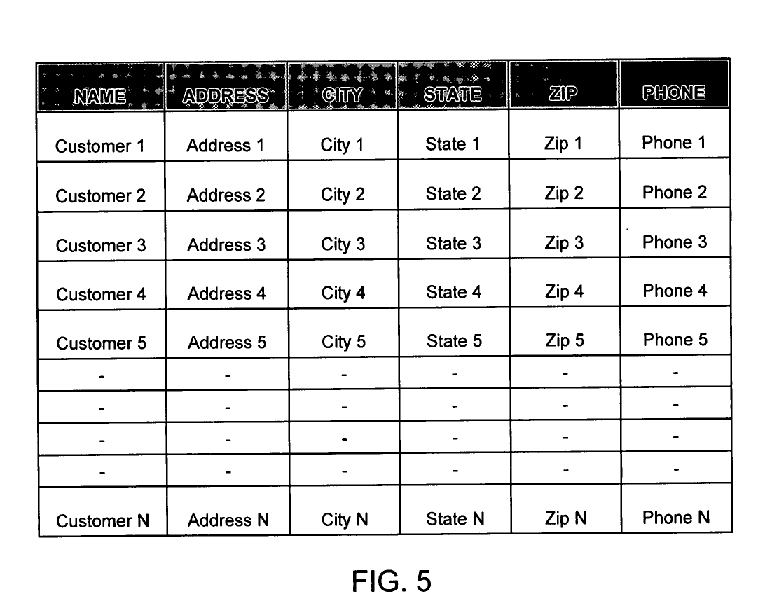

FIG. 5 is a sample standardized customer list, in accordance with an exemplary embodiment of the present invention, illustrating a typical convention for the ordering of a data table containing a number of primary variables. The demographic characteristics of customers, such as address, city, state, zip and phone, are shown in the list. However, it will be apparent to those skilled in the art that other demographic characteristics of the customers may also be present in the standardized customer list.

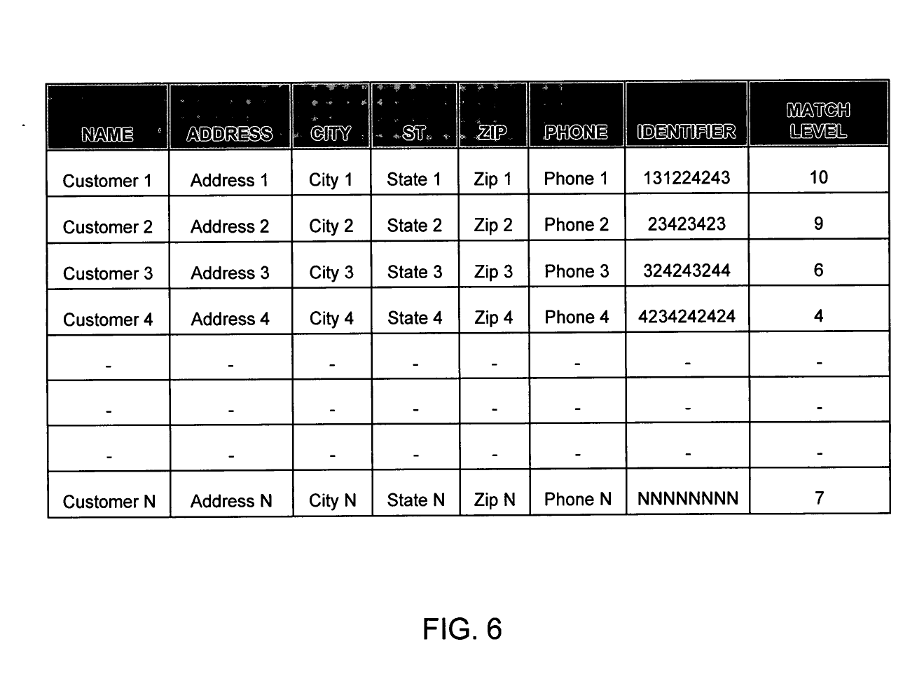

At step 408, an identifier is assigned to each record present in the standardized customer list and the standardized marketing reference file. In an embodiment of the present invention, the identifier is a 10-digit number. At step 410, the records in the standardized customer list are matched with the records present in the standardized marketing reference file. Further, match levels are assigned to each record in the standardized customer list. The method employed for matching the records present in the standardized marketing reference file and the records present in the standardized customer list is described later. FIG. 6 shows a sample standardized customer list with match levels assigned to each record, in accordance with an exemplary embodiment of the present invention. At step 412, a set of records from the standardized customer list is short-listed on the basis of match levels. For example, records with a match level above a pre-defined threshold value are short-listed as the closest matching records. At step 414, the short-listed set of records obtained in step 412 is integrated with the standardized marketing reference file to obtain integrated marketing reference list 106. In an embodiment of the present invention, each record in integrated marketing reference list 106 is assigned a variable ‘record type’. The variable ‘record type’ of an existing customer record has a value equal to 1, and the variable ‘record type’ of a prospective customer record has a value equal to 0. Duplicate records are removed from integrated marketing reference list 106 to obtain only one record per existing customer/prospect. Whether or not a record is considered a duplicate record is determined by its match level, and whether or not its match level is above or below the pre-defined threshold.

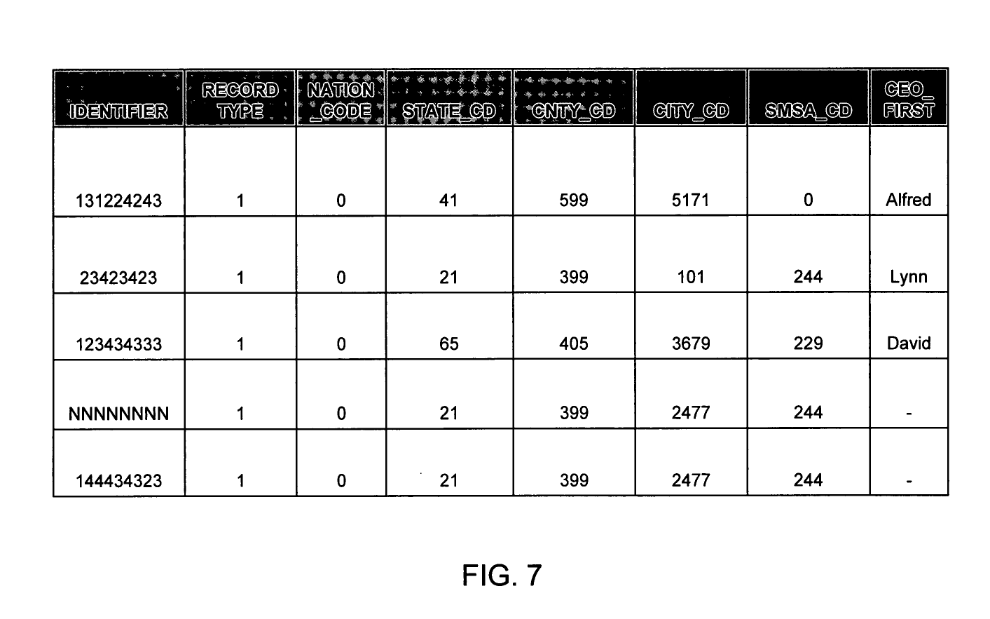

There are two kinds of variables present in integrated marketing reference list 106, namely, primary variables and derived variables. Some examples of primary variables are address-state, address-country, smsa-cd, ceo-title, and population-cd. Some examples of derived variables are binary variables, missing indicator variables, continuous variables, regional indicators, standard industrial classification (SIC) variables, affinity-ratio variables and capped-variables. FIG. 7 shows a sample integrated marketing reference list, in accordance with an exemplary embodiment of the present invention.

At step 416, the primary variables present in integrated marketing reference list 106 are used to compute derived variables for each record in integrated marketing reference list 106. The derived variables can be divided into two groups. The first group of derived variables includes variables that need to be computed only once for each integrated marketing reference list, are not specific for a particular user, and do not depend upon the number of times the method described in conjunction with FIG. 4 is carried out. The second group of derived variables is specific to the user and are computed each time the method described in conjunction with FIG. 4 is carried out.

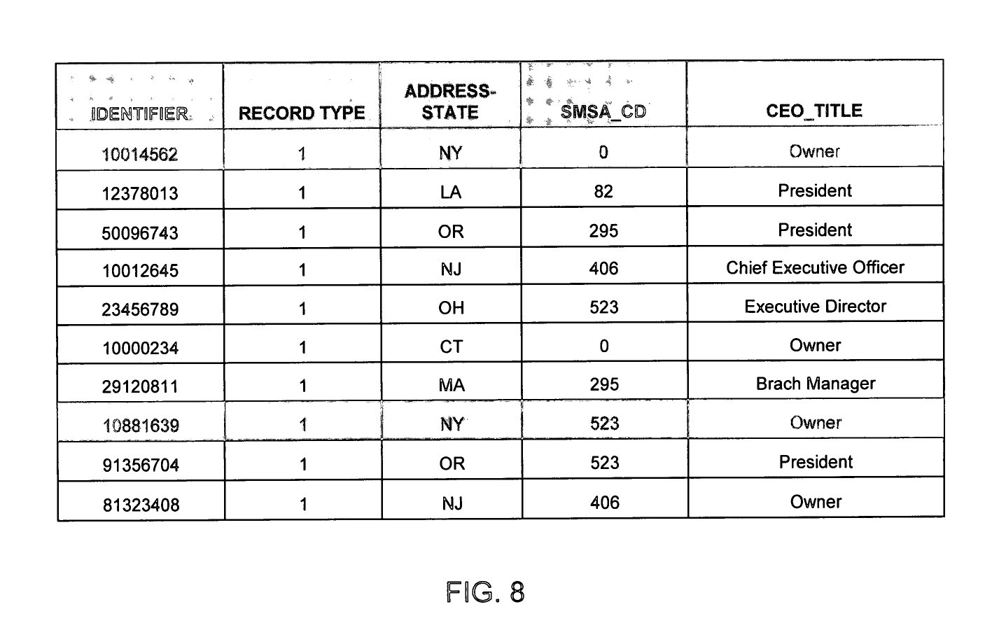

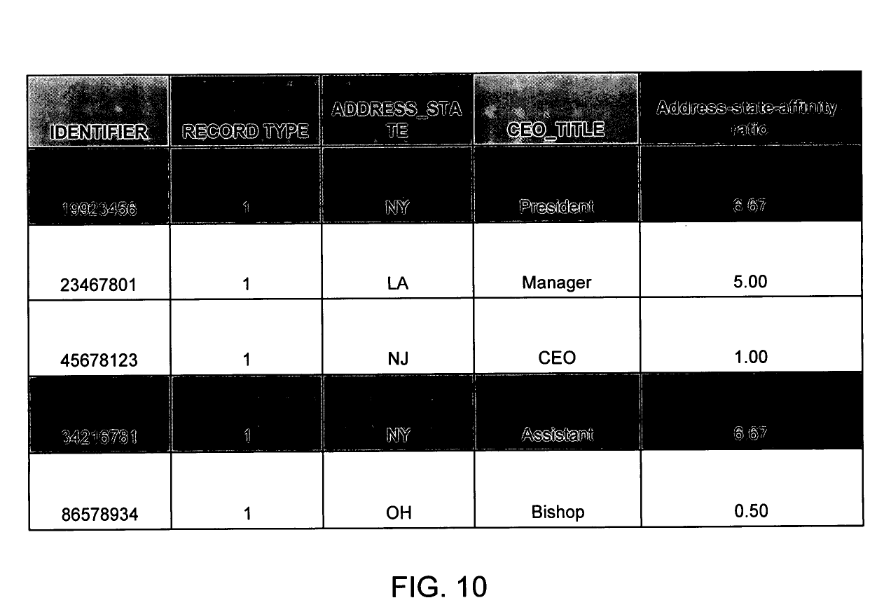

Examples of derived variables and their computation are described later in this patent application in conjunction with FIG. 8, FIG, 9 and FIG. 10.

At step 418, integrated marketing reference list 106 is appended with the values of all the derived variables belonging to the first group and the second group. At step 420, a sample set of records is generated. The sample set includes all the records present in the standardized customer list and an equal number of records with record type=0. The records with record type=0 are randomly selected from integrated marketing reference list 106. Therefore, the sample list includes 50 percent existing customers and 50 percent prospects. At step 422, the sample set is further divided into two sub-sample sets. A first sub-sample set includes two-thirds of the records in the sample set and a second sub-sample set includes the remaining one-third of the records in the sample set. The division of the sample set into the two sub-sample sets is random but the proportion of existing customers to prospects is kept fixed. For example, in a sample set of 800 records, 400 out of which being customers prior to the division, after division, the first sub-sample set will contain 533 records (⅔^{rd} of 800 records) in total and 267 of the 533 records will be customers. Further, the second sub-sample set will contain 267 records (⅓^{rd} of 800 records) and 133 of the 267 records will be customers.

At step 424, the first sub-sample set is used for building predictive model 108, and a final list of essential variables is obtained. In an embodiment of the present invention, predictive model 108 is a logistic regression model with an option for a backward elimination process. At step 426, the second sub-sample set is input into predictive model 108, scores are computed for each record in the second sub-sample set, and the performance of predictive model 108 is validated. The final list of variables and their corresponding coefficients obtained in step 424 are also input into predictive model 108. At step 426, the score of each record in the second sub-sample set is computed based on the final list of essential variables obtained in step 424.

At step 428, each derived variable present in the final list of the essential variables obtained in step 424 is computed for all the records present in integrated marketing reference list 106, according to step 416. At step 430, integrated marketing reference list 106 is input into predictive model 108. Further, the scores are obtained for each record present in integrated marketing reference list 106, as obtained for the records present in the second sub-sample set, at step 426. At step 432, the records present in integrated marketing reference list 106 are sorted according to the scores obtained for each record present in integrated marketing reference list 106, according to step 430. At step 434, output list 112 of records is generated by list selection tool 110, from the records present in integrated marketing reference list 106, based on the scores and a list of requirements provided by the user. The list of requirements provided by the user may include demographic factors/preferences of the user, such as, but not limited to, the interest of the user to obtain customers in a particular location, or customers meeting a minimum revenue threshold requirement. Output list 112 does not contain any records of existing customers present in customer list 102.

The standardization of each variable in customer list 102 and marketing reference file 104 are done according to pre-define methods. In an embodiment of the present invention, the method of standardization of the variable ‘company name’ is performed in four steps. The first step includes the replacement of all spaces and special characters with their equivalents specified in a special words table. The special words table includes alternative equivalent characters assigned to each special character. In the second step, common words such as ‘Inc’ and ‘CO’ are removed from the company name if they occur at the end of company name. The third step includes replacing all plural words with their singular forms, with the help of a plurality standardization table. The plurality standardization table includes a list of singular forms corresponding to plural words. Finally, the fourth step includes replacing words with normalized words using a word normalization table.

For matching the records present in the standardized marketing reference file and the records present in the standardized customer list, the identifier of each record in the standardized customer list is compared with the identifier of each record in the standardized marketing reference file. Further, variables corresponding to each record in the standardized customer list are compared with the variables corresponding to each record in the standardized marketing reference file. A match score is assigned to each record in the standardized customer list, wherein the match score represents the degree of match between any two records. In an embodiment of the present invention, the match score assigned to each record is based on the percentage of duples and triples matches between a record in the standardized customer list and records present in the standardized marketing reference file. The match score for a record is the average of the duple score and the triple score for the record, wherein the duple score is the percentage of duple matches between the record and a particular record present in the marketing reference file, The triple score is the percentage of triple matches between the record and a particular record present in the standardized marketing reference file.

In an-embodiment of the present invention, the duple score of the company name is computed by splitting the company name into several combinations of two-letter words. For example, Merck is split into ten duples, namely, me, mr, mc, mk, er, ec, ek, rc, rk, and ck. The duple score is 100×number of common duples between the company names present in a record in the standardized customer list and the records present in the standardized marketing reference file. Similarly, triple score is 100×number of common triples between the company names present in the record in the standardized customer list and the records present in the standardized marketing reference file.

Finally, a match level is assigned to each record in the standardized customer list based on the match score assigned to each record, using a match score table. The match score table includes a match level assigned to each match score, wherein, in an embodiment of the present invention, there are five match levels.

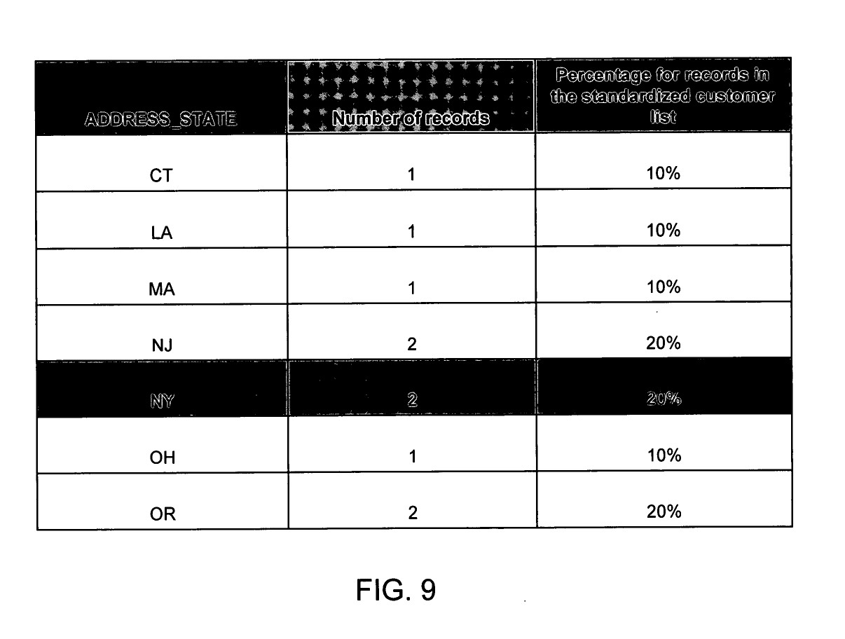

FIG. 9 represents a sample standardized customer list from which the variable address-state-affinity-ratio for address-state=NY is computed, in accordance with an exemplary embodiment of the present invention. The numerator of the address-state-affinity-ratio for address-state=NY is the percentage of records in the standardized customer list with address-state=NY. According to FIG. 8, two out of ten customer records in the standardized customer list have address-state=NY. Therefore, the numerator of the address-state-affinity-ratio is 20 percent. FIG. 9 shows a list of numerators for the address-state-affinity-ratios for address-states=NY, LA, OR, NJ, OH, CT and MA, in accordance with an exemplary embodiment of the present invention.

Similarly, in an embodiment of the present invention, the denominator of the address-state-affinity-ratio for address-state=NY is the percentage of records in integrated marketing reference list 106 with address-state=NY. By way of example, in which 3% of all records of particular integrated marketing reference list include the address-state variable New York, the denominator for the address-state-affinity-ratio for address-state=NY becomes 3 percent. Therefore, the address-state-affinity-ratio for address-state=NY is 20%/3% or 6.67. FIG. 10 shows a subset of integrated marketing reference list 106 appended with a list of address-state-affinity-ratios, in accordance with an exemplary embodiment of the present invention. Some examples of primary variables for which affinity-ratios are calculated are address-state, smsa-cd, ceo-title, and population-cd. Affinity-ratios are not computed for the continuous primary variables. However, a variable representing an upper limit for each continuous variable is computed, and is known as a capped-variable. Some examples of primary variables for which capped variables are computed are sales-volume, employee-total and sqr-footage.

In an embodiment of the present invention, the process for determining the capped-variable for a continuous primary variable is performed in three steps. At the first step, integrated marketing reference list 106 is sorted in the ascending order of the values for a particular continuous primary variable. At the second step, the value of the variable which is greater than 99 percent of the other occurrences of the variable, is taken as the 99th percentile value. The 99th percentile is also referred to as P99. Finally, in the third step, if the value of the variable for a particular record is greater than P99, the value of the variable for that record is replaced by P99. For example,

```
if (sales-volume > P99ₛₐₗₑₛ₋ᵥₒₗᵤₘₑ)
    then
        capped-sales-volume = P99ₛₐₗₑₛ₋ᵥₒₗᵤₘₑ
    else
        capped-sales-volume = sales-volume
```

Therefore, an upper limit of P99 is applied to the continuous capped variable. Capped-variables are computed for all continuous primary variables.

The values of variables so obtained are input to the predictive model to obtain scores for the records in the integrated marketing reference list 106. The scores are then used to shortlist records representing prospects to form output list 112, as described in conjunction with FIG. 4.

Various embodiments of the present invention provide a rank-ordered list of prospective customers for a user based on the user's requirements. The rank-ordered list is generated based on the scores generated by the predictive model described in the present invention and is not just based on the demographic details of each record. The method reduces the cost of conducting a marketing campaign based on the list of prospective customers, as the list of customers selected includes customers that are more likely to respond to the marketing campaign. Further, a lot of investment is required for obtaining such a large list of prospective customers. The present invention saves the cost incurred for obtaining such a large list, and the user needs to pay for only the list of prospective customers generated by the method described in the present invention. Further, the present invention can provide prospective customer lists for different kinds of requirements for the same user or different users. Finally, the method described in the present invention allows marketers of all sizes and budgets to generate their rank-ordered list of prospects with a fast turnaround that fits within existing marketing infrastructure.

The system for, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device, which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element resident within the processing machine. Exemplary storage elements include a hard disk, and EPROMs. The storage element may also be external to the computer system, and connected or inserted into the computer for download at or prior to the time of use. Exemplary of such external computer program products are computer readable storage mediums such as CD-ROMs, Flash Memory Chips, floppy disks, and the like.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the foregoing is directed to embodiments of the present invention, other and further embodiments of the invention may be devised without departing from the basic scope thereof, and the scope thereof is determined by the claims that follow.

What is claimed is:

1. A method for identifying a list of prospective customers, the method comprising the steps of:
integrating an existing customer list into a marketing reference file, wherein the marketing reference file comprises a plurality of records;
building a predictive model based on one or more attributes present in the marketing reference file;
assigning scores to each of the plurality of records in the marketing reference file based on the predictive model; and
creating a rank-ordered list of records based on the scores.

2. The method of claim 1, wherein the step of building the predictive model comprises the step of employing a logistic regression algorithm.

3. The method of claim 1, wherein the attributes present in the marketing reference file characterize each of the plurality of records.

4. The method of claim 3, wherein the predictive model comprises the one or more attributes.

5. The method of claim 3, wherein each of the one or more attributes is selected from a group comprising type of ownership, size, revenue, sales, business age, number of employees, growth rate, and geography.

6. The method of claim 1, wherein the step of creating the rank-ordered list of records comprises the step of fulfilling a list of requirements.

7. The method of claim 1, wherein the step of creating the rank-ordered list of records comprises the step of removing records belonging to the customer list, from the rank-ordered list of records.

8. The method of claim 1, wherein the customer list is provided by a user.

9. A system for identifying a list of prospective customers, the system comprising:
a. an existing customer list identifying present customers;
b. a marketing reference file comprising a plurality of records;
c. a predictive model based on the customer list and one or more attributes present in the marketing reference file; and
d. a list selection tool for creating a rank-ordered list of records based on the marketing reference file and the predictive model.

10. The system of claim 9, wherein the predictive model comprises a logistic regression algorithm.

11. The system of claim 9, wherein the one or more attributes characterize each of the plurality of records.

12. The system of claim 9, wherein each of the plurality of records represents a prospective customer.

13. A computer program for identifying a list of prospective customers comprising a on a computer readable medium resident within a computer, the computer readable program code containing instructions for performing the steps of:
a. integrating an existing customer list into a marketing reference file, wherein the marketing reference file comprises a plurality of records;
b. building a predictive model based on one or more attributes present in the marketing reference file;
c. assigning scores to each of the plurality of records in the marketing reference file based on the predictive model; and
d. creating a rank-ordered list of records based on the scores.

14. The computer program product of claim 13, wherein the computer readable code performing the step of building the predictive model comprises a computer readable program code performing the step of executing a logistic regression algorithm.

15. The computer program product of claim 13, wherein the one or more attributes characterize each of the plurality of records.

16. The computer program product of claim 15, wherein the predictive model comprises the one or more attributes.

17. The computer program product of claim 13, wherein the computer readable code performing the step of creating the rank-ordered list of records comprises a computer readable program code performing the step of fulfilling a list of requirements.

18. The computer program product of claim 13, wherein the computer readable code performing the step of creating the rank-ordered list of records comprises a computer readable program code performing the step of removing records belonging to the customer list, from the rank-ordered list of records.

19. The computer program product of claim 13, wherein each of the plurality of records represents a prospective customer.

20. A computer program product for identifying a list of prospective customers, the computer program product comprising a computer readable medium having a computer readable program code embodied therein, the computer readable program code containing instructions for performing the steps of:
a. integrating an existing customer list into a marketing reference file, wherein the marketing reference file comprises a plurality of records;
b. building a predictive model based on one or more attributes present in the marketing reference file;
c. assigning scores to each of the plurality of records in the marketing reference file based on the predictive model; and
d. creating a rank-ordered list of records based on the scores.
